(19) United States
(12) Patent Application Publication
(10) Pub. No.: US 2021/0019727 A1
(43) Pub. Date: Jan. 21, 2021

(54) ASSOCIATING MERCHANT DATA WITH A MONETARY WITHDRAWAL FROM A TRANSACTION DEVICE BASED ON A LOCATION OF THE TRANSACTION DEVICE

(71) Applicant: Capital One Services, LLC, McLean, VA (US)

(72) Inventors: Joshua EDWARDS, Philadelphia, PA (US); Abdelkadar M'Hamed BENKREIRA, Washington, DC (US); Michael MOSSOBA, Arlington, VA (US)

(21) Appl. No.: 16/512,958

(22) Filed: Jul. 16, 2019

(51) Int. Cl. G06Q 20/32; G06N 20/00; G06F 17/27

(52) U.S. Cl. CPC G06Q 20/3223; G06F 17/2705; G06N 20/00; G06Q 20/3224

(57) ABSTRACT

A device receives transaction data identifying a monetary withdrawal, by a user, from a transaction device located at or near a merchant location, and receives location data indicating a location of a user device at a time period after receiving the transaction data. The device processes the transaction data and the location data to identify a merchant associated with the merchant location, and processes information identifying the merchant to generate a notification requesting that the user identify an amount of the monetary withdrawal that was spent with the merchant. The device provides the notification to the user device, and receives a response indicating the amount of the monetary withdrawal. The device identifies the amount of the monetary withdrawal, and associates the amount of the monetary withdrawal with information identifying the merchant, a category of the merchant, and an account of the user.

### BACKGROUND

A transaction device may include an automated teller machine (ATM) device, a point of sale (POS) device, a kiosk device, and/or the like. A user of a transaction device may conduct a variety of transactions via the transaction device, such as receiving money, depositing money, checking an account balance, and/or the like.

### SUMMARY

According to some implementations, a method may include receiving, from a transaction device, transaction data identifying a monetary withdrawal, by a user, from the transaction device located at or near a merchant location, and receiving, from a user device associated with the user, location data indicating a location of the user device at a time period after receiving the transaction data. The method may include processing the transaction data and the location data, with a model, to identify a merchant associated with the merchant location and with the transaction device, and utilizing natural language processing on information identifying the merchant to generate a notification requesting that the user identify an amount of the monetary withdrawal from the transaction device that was spent with the merchant. The method may include determining a particular time to provide the notification to the user device based on the information identifying the merchant, and providing the notification to the user device at the particular time. The method may include receiving, from the user device, a response indicating the amount of the monetary withdrawal from the transaction device that was spent with the merchant, wherein the response may be provided by the user device based on the notification, and utilizing natural language processing to parse the response and identify the amount of the monetary withdrawal that was spent with the merchant. The method may include associating the amount of the monetary withdrawal with information identifying the merchant, a category of the merchant, and an account of the user, and performing one or more actions based on associating the amount of the monetary withdrawal with the information identifying the merchant, the category of the merchant, and the account of the user.

According to some implementations, a device may include one or more memories, and one or more processors, communicatively coupled to the one or more memories, to receive, from a transaction device, transaction data identifying a monetary withdrawal, by a user, from the transaction device located at or near a merchant location, and receive, from a user device associated with the user, location data indicating a location of the user device at a time period after receiving the transaction data. The one or more processors may process the transaction data and the location data, with a machine learning model, to identify a merchant associated with the merchant location, and may perform natural language processing on information identifying the merchant to generate a notification requesting that the user identify an amount of the monetary withdrawal that was spent with the merchant. The one or more processors may provide the notification to the user device, and may receive, from the user device, a response indicating the amount of the monetary withdrawal that was spent with the merchant, wherein the response may be provided by the user device based on the notification. The one or more processors may perform natural language processing on the response to identify the amount of the monetary withdrawal that was spent with the merchant, and may associate the amount of the monetary withdrawal with information identifying the merchant, a category of the merchant, and an account of the user. The one or more processors may store information identifying an association of the amount of the monetary withdrawal with the information identifying the merchant, the category of the merchant, and the account of the user.

According to some implementations, a non-transitory computer-readable medium may store instructions that include one or more instructions that, when executed by one or more processors of a device, cause the one or more processors to receive, from a transaction device, transaction data identifying a monetary withdrawal, by a user, from the transaction device located at or near a merchant location, and receive, from a user device associated with the user, location data indicating a location of the user device at a time period after receiving the transaction data. The one or more instructions may cause the one or more processors to process the transaction data and the location data, with a machine learning model, to identify a merchant associated with the merchant location and with the transaction device, and utilize natural language processing on information identifying the merchant to generate a notification requesting that the user identify an amount of the monetary withdrawal that was spent with the merchant. The one or more instructions may cause the one or more processors to provide the notification to the user device, and receive, from the user device, a response to the notification, wherein the response may indicate the amount of the monetary withdrawal that was spent with the merchant. The one or more instructions may cause the one or more processors to utilize natural language processing on the response to identify the amount of the monetary withdrawal that was spent with the merchant, and associate the amount of the monetary withdrawal with information identifying the merchant, a category of the merchant, and an account of the user. The one or more instructions may cause the one or more processors to perform one or more actions based on associating the amount of the monetary withdrawal with the information identifying the merchant, the category of the merchant, and the account of the user.

### BRIEF DESCRIPTION OF THE DRAWINGS

FIGS. 1A-1G are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for associating merchant data with a monetary withdrawal from a transaction device based on a location of the transaction device.

### DETAILED DESCRIPTION

The following detailed description of example implementations refers to the accompanying drawings. The same reference numbers in different drawings may identify the same or similar elements.

Sometimes a user utilizes a transaction device to make a monetary withdrawal (e.g., cash) from the transaction device. The user may then spend the cash with one or more merchants. A financial system tracks the amount of money withdrawn from the transaction device. For example, the financial system may debit the user's financial account from which the money is withdrawn. Thus, an electronic record may exist regarding the fact that the money has been withdrawn. However, identifying the one or more merchants and tracking the amount of the withdrawn money spent at each of the one or more merchants is technically complex.

Some implementations described herein provide a verification platform that associates a merchant with a monetary withdrawal from a transaction device based on a location of the transaction device. For example, the verification platform may receive, from a transaction device, transaction data identifying a monetary withdrawal, by a user, from the transaction device located at or near a merchant location, and may receive, from a user device associated with the user and based on sensor data from one or more sensors associated with the user device, location data indicating a location of the user device at a time period after receiving the transaction data. The verification platform may process the transaction data and the location data, with a model, to identify a merchant associated with the merchant location and with the transaction device, and may utilize natural language processing on information identifying the merchant to generate a notification requesting that the user identify an amount of the monetary withdrawal from the transaction device that was spent with the merchant. The verification platform may determine a particular time to provide the notification to the user device based on the information identifying the merchant, and may provide the notification to the user device at the particular time. The verification platform may receive, from the user device and based on the notification, a response indicating the amount of the monetary withdrawal from the transaction device that was spent with the merchant, and may utilize natural language processing to parse the response and identify the amount of the monetary withdrawal that was spent with the merchant. The verification platform may associate the amount of the monetary withdrawal with information identifying the merchant, a category of the merchant, and an account of the user, and may perform one or more actions based on associating the amount of the monetary withdrawal with the information identifying the merchant, the category of the merchant, and the account of the user.

In this way, the verification platform enables the user to generate and/or update a budget for monetary withdrawals from transaction devices, search for transactions associated with the monetary withdrawals, organize an account of the user based on the monetary withdrawals, and/or the like. Furthermore, the verification platform uses location information, associated with a transaction device, and sensor data, associated with a user device, to determine an association between the monetary withdrawals and one or more merchants.

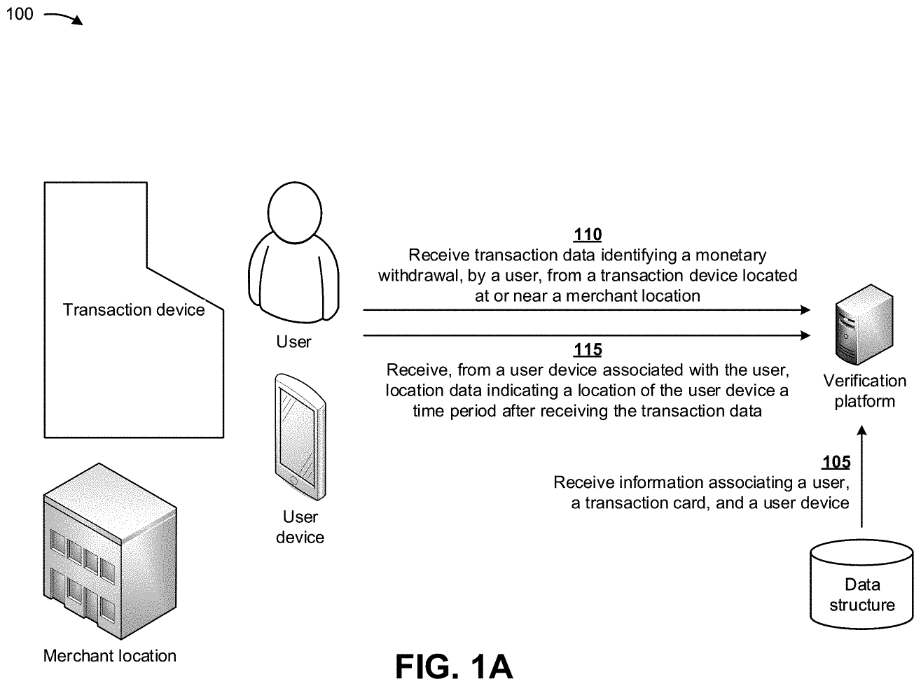

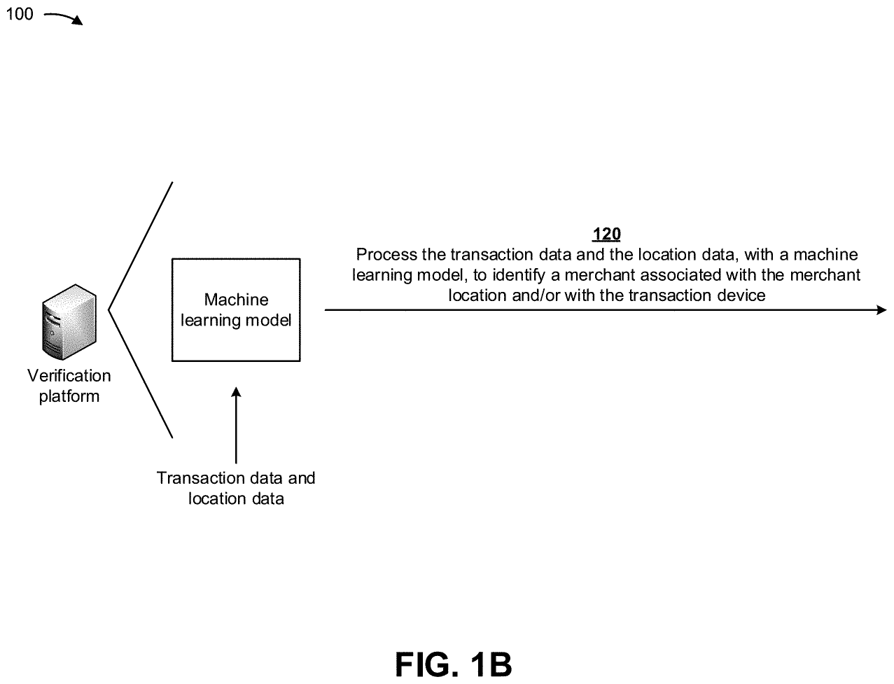

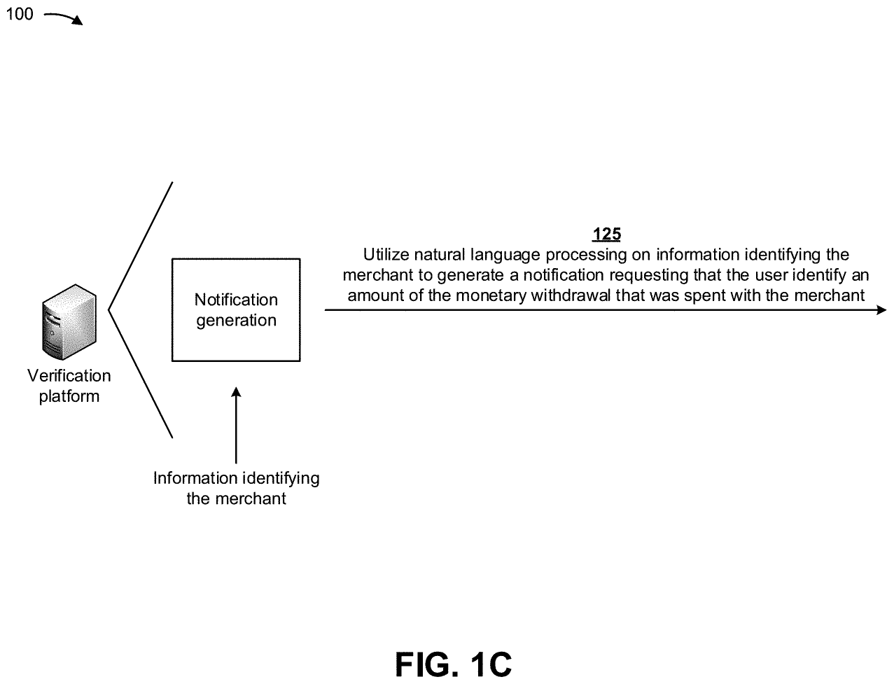

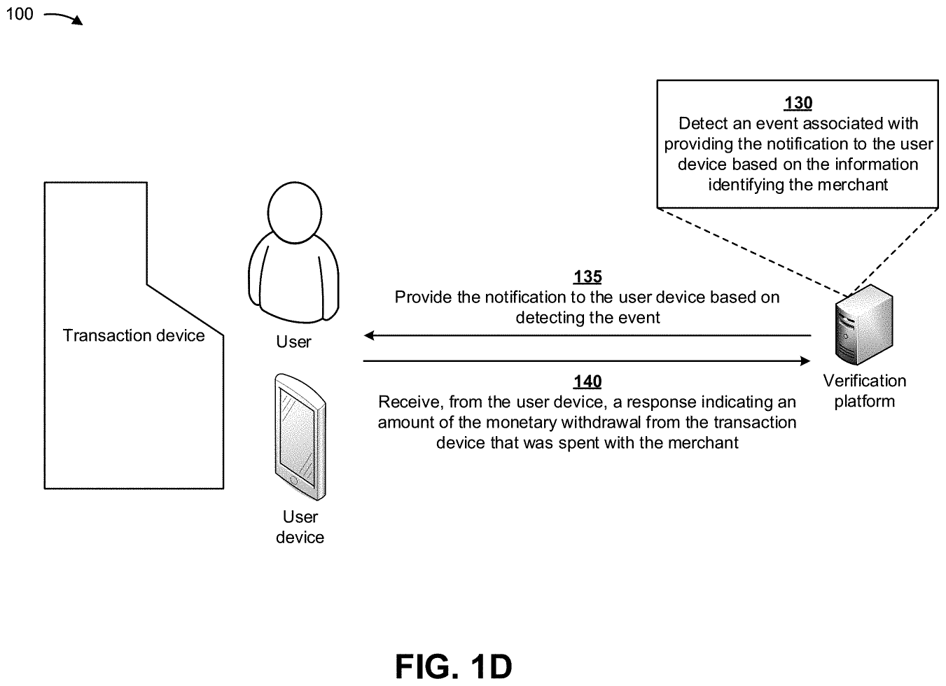

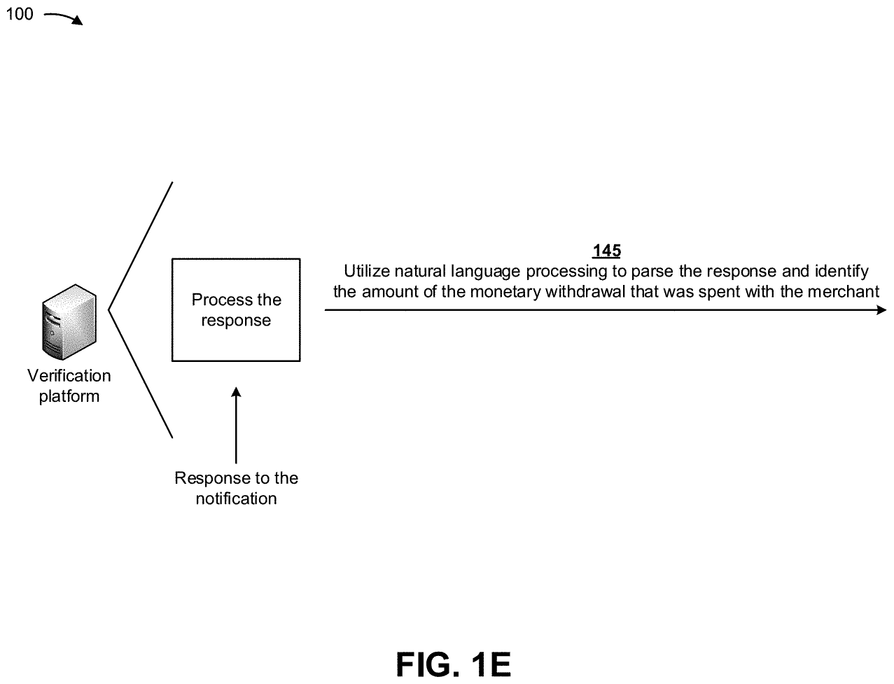

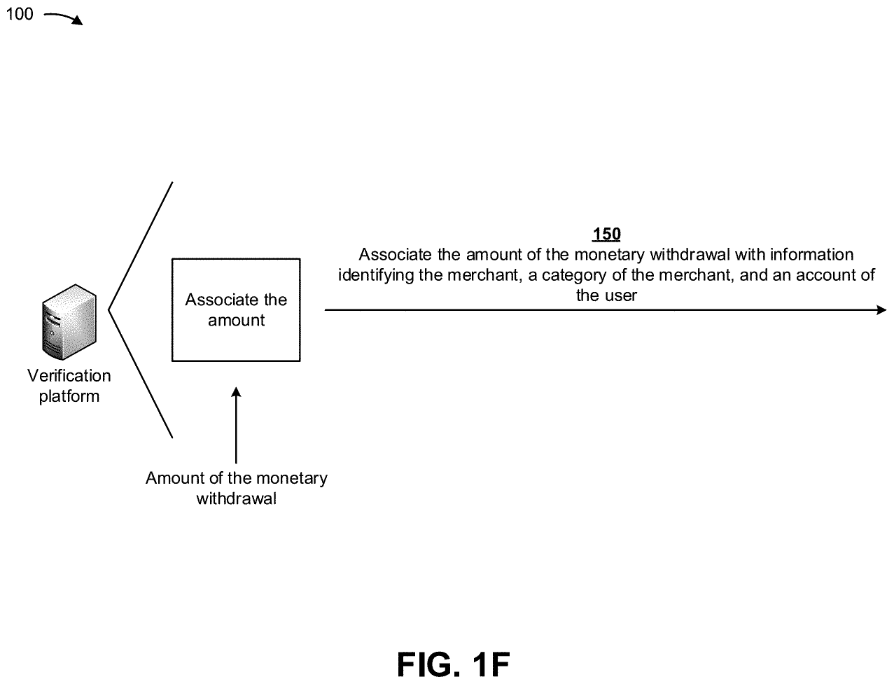

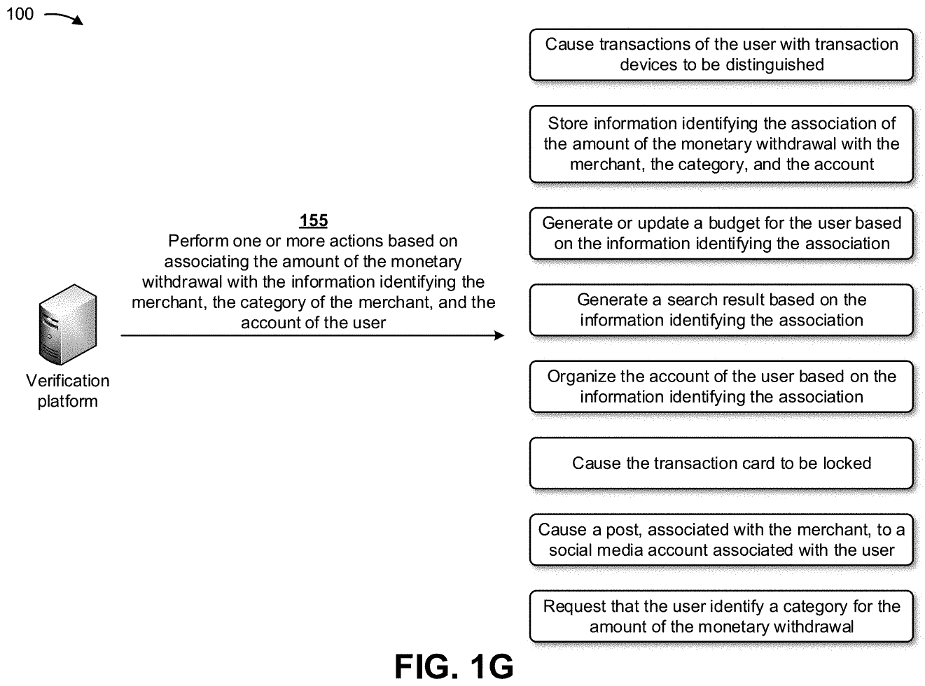

FIGS. 1A-1G are diagrams of one or more example implementations 100 described herein. As shown in FIG. 1A, a transaction device may be associated with a verification platform, a user, and a user device of the user. The transaction device may be located at or near a merchant location (e.g., a location associated with a merchant). In some implementations, the verification platform may determine that the transaction device is located at or near the merchant location based on global positioning system (GPS) coordinates associated with the transaction device and/or the merchant location, GPS coordinates associated with the user device, third-party data indicating a location of the transaction device and the merchant location, a tag (e.g., a geotag) associated with the transaction device, and/or the like. In some implementations, the verification platform may determine that the transaction device is located near the merchant location based on a threshold distance (e.g., in meters, kilometers, and/or the like) between a location of the transaction device and the merchant location. In such implementations, the verification platform may calculate a distance between the location of the transaction device and the merchant location, may determine whether the distance satisfies the threshold distance, and may determine that the transaction device is located at or near the merchant location when the distance satisfies the threshold distance.

As further shown in FIG. 1A, and by reference number 105, the verification platform may receive, from a data structure (e.g., a database, a table, a list, and/or the like) associated with the verification platform, information associating a user, a transaction card of the user, and the user device. In some implementations, the information associating the user, the transaction card, and the user device may be provided from information associated with an account of the user at a financial institution. The verification platform may utilize the information associating the user, the transaction card, and the user device in order to communicate with the user device, receive location data from the user device, receive transaction data from the user device, and/or the like.

The user may log into the transaction device (e.g., with a transaction card and/or the user device) to conduct a transaction (e.g., a withdrawal, a deposit, a transfer, and/or the like) via the transaction device. As further shown in FIG. 1A, and by reference number 110, the verification platform may receive transaction data identifying a monetary withdrawal, by the user, from the transaction device located at or near the merchant location. In some implementations, the transaction data may include data identifying the user, an account associated with the user, the transaction being conducted by the user (e.g., a monetary withdrawal), the transaction device, a location of the transaction device, and/or the like. In some implementations, the verification platform may be associated with hundreds, thousands, millions, and/or the like of transaction devices, user devices, and users and may receive transaction data from the transaction devices.

As further shown in FIG. 1A, and by reference number 115, the verification platform may receive, from the user device associated with the user, location data indicating a location of the user device a time period after receiving the transaction data. In some implementations, the location data may include sensor data (e.g., GPS coordinates) received from one or more sensors of the user device for the time period after receiving the transaction data. For example, the user may make the monetary withdrawal from the transaction device, may travel to the merchant location with the user device, and may spend some or all of the monetary withdrawal with a merchant associated with the merchant location.

As shown in FIG. 1B, and by reference number 120, the verification platform may process the transaction data and the location data, with a machine learning model, to identify a merchant associated with the merchant location and/or with the transaction device. In some implementations, the machine learning model may include a pattern recognition model that generates predictions of merchants based on transaction data and location data. For example, the machine learning model may predict that individuals who withdraw more than a threshold amount of money, at a particular time of the day and from a particular transaction device, tend to spend that money at a first merchant that is within a particular geographic distance of the transaction device, and predict that individuals who withdraw less than the threshold amount of money, at the particular time of the day and from the particular transaction device, tend to spend that money at a second merchant that is within the particular geographic distance of the transaction device. In some implementations, the verification platform may receive additional sensor data (e.g., location data) from the user device, which may aid in identifying a merchant at which the user may have spent some of the withdrawn money.

In some implementations, the verification platform may perform a training operation on the machine learning model with historical transaction and location data. The historical transaction and location data may include data identifying transactions by users of transaction devices, data identifying merchants located at or near the transaction devices, data indicating that the users made monetary withdrawals from the transaction devices and spent some or all of the monetary withdrawals with one or more of the merchants, data indicating that the users made monetary withdrawals from the transaction devices but did not spend the monetary withdrawals with one or more of the merchants, and/or the like.

In some implementations, the verification platform may separate the historical transaction and location data into a training set, a validation set, a test set, and/or the like. The training set may be utilized to train the machine learning model. The validation set may be utilized to validate results generated based on training the machine learning model with the training set. The test set may be utilized to test results generated by the trained machine learning model.

In some implementations, the verification platform may train the machine learning model using, for example, an unsupervised training procedure and based on the training set of the historical transaction and location data. For example, the verification platform may perform dimensionality reduction to reduce the historical transaction and location data to a minimum feature set, thereby reducing resources (e.g., processing resources, memory resources, and/or the like) to train the machine learning model and may apply a classification technique to the minimum feature set.

In some implementations, the verification platform may use a logistic regression classification technique to determine a categorical outcome (e.g., identification of merchants based on the historical transaction and location data). Additionally, or alternatively, the verification platform may use a naïve Bayesian classifier technique. In this case, the verification platform may perform binary recursive partitioning to split the historical transaction and location data into partitions and/or branches and use the partitions and/or branches to perform predictions (e.g., identification of merchants based on the historical transaction and location data). Based on using recursive partitioning, the verification platform may reduce utilization of computing resources relative to manual, linear sorting and analysis of data points, thereby enabling use of thousands, millions, or billions of data points to train the machine learning model, which may result in a more accurate model than using fewer data points.

Additionally, or alternatively, the verification platform may use a support vector machine (SVM) classifier technique to generate a non-linear boundary between data points in the training set. In this case, the non-linear boundary is used to classify test data into a particular class.

Additionally, or alternatively, the verification platform may train the machine learning model using a supervised training procedure that includes receiving input to the machine learning model from a subject matter expert, which may reduce an amount of time, an amount of processing resources, and/or the like to train the machine learning model relative to an unsupervised training procedure. In some implementations, the verification platform may use one or more other model training techniques, such as a neural network technique, a latent semantic indexing technique, and/or the like. For example, the verification platform may perform an artificial neural network processing technique (e.g., using a two-layer feedforward neural network architecture, a three-layer feedforward neural network architecture, and/or the like) to perform pattern recognition with regard to optimal regions of the historical transaction and location data. In this case, using the artificial neural network processing technique may improve an accuracy of the trained machine learning model generated by the verification platform by enabling the model to be more robust than unprocessed models to noisy, imprecise, or incomplete data, and by enabling the verification platform to detect patterns and/or trends undetectable to human analysts or systems using less complex techniques.

In some implementations, the verification platform may receive the trained machine learning model from another source. In such implementations, the verification platform may utilize the trained machine learning model to process transaction data and location data and to identify one or more merchants based on the transaction data and the location data.

In this way, the verification platform may provide the transaction data and the location data as an input to the machine learning model, and the machine learning model may output information identification a merchant associated with the merchant location and/or with the transaction device based on the input.

As shown in FIG. 1C, and by reference number 125, the verification platform may utilize natural language processing on information identifying the merchant to generate a notification requesting that the user identify an amount of the monetary withdrawal that was spent with the merchant. In some implementations, the verification platform may utilize a natural language processing technique, a computational linguistics technique, a text analysis technique, and/or the like, with the information identifying the merchant in order to generate a notification requesting that the user identify an amount of the monetary withdrawal that was spent with the merchant. For example, the verification platform may apply natural language processing to interpret the information identifying the merchant and generate additional data associated with the potential meaning of data within the information identifying the merchant. In some implementations, the verification platform may generate questions about the merchant and how much of the monetary withdrawal was spent with the merchant utilizing natural language processing. For example, for a merchant with a name “Joe's Pizza,” the verification platform may utilize natural language processing to formulate questions (e.g., for the notification), such as “it looks like you bought pizza at Joe's Pizza, how much cash did you spend for the pizza?”

Natural language processing involves techniques performed (e.g., by a computer system) to analyze, understand, and derive meaning from human language in a useful way. Rather than treating text like a mere sequence of symbols, natural language processing considers a hierarchical structure of language (e.g., several words can be treated as a phrase, several phrases can be treated as a sentence, and the words, phrases, and/or sentences convey ideas that can be interpreted). Natural language processing can be applied to analyze text, allowing machines to understand how humans speak, enabling real world applications such as automatic text summarization, sentiment analysis, topic extraction, named entity recognition, parts-of-speech tagging, relationship extraction, stemming, and/or the like.

In some implementations, the user may select how the notification is to be received by the user (e.g., via a SMS message, an instant message, an email, a telephone call, an application, and/or the like), when the notification is to be received, and/or the like.

As shown in FIG. 1D, and by reference number 130, the verification platform may detect an event associated with providing the notification to the user device based on the information identifying the merchant. In some implementations, the event associated with providing the notification to the user device may include a particular time to provide the notification to the user device. For example, the verification platform may determine, based on location data from the user device, that the user is leaving the merchant location, and may determine the particular time as when the user is leaving the merchant location. In another example, the verification platform may determine a first particular time to provide the notification to the user when the category of the merchant is a first category (e.g., when the merchant is a restaurant, the notification may be provided to the user device within an hour), may determine a second particular time to provide the notification when the category of the merchant is a second category (e.g., when the merchant is an amusement park, the notification may be provided after two, three, etc. hours), and/or the like.

In some implementations, the event associated with providing the notification to the user device may include the location data, from the user device, indicating that the user is moving away from the merchant location, the location data indicating that the user is located at the merchant location, the location data indicating that the user is moving away from the transaction device, a time period elapsing, a location of the user, the location data indicating that the user is more than a threshold geographic distance away from the merchant location, that the user is utilizing the user device, and/or a combination of the aforementioned events (e.g., that the user is using the user device and is more than the threshold geographic distance away from the merchant location). In some implementations, the verification platform may test a variety of different events and may determine, through modeling, which events are the best (e.g., the events that lead to the highest degree of success in getting a response to the notification from the user).

As further shown in FIG. 1D, and by reference number 135, the verification platform may provide the notification (e.g., via short message service (SMS) message, an instant message, an email, a telephone call, and/or the like) to the user device based on detecting the event. For example, if the location data indicates that that user is leaving the merchant location, the verification platform may provide the notification to the user device. In some implementations, the user device may receive the notification and may display the notification to the user. For example, the user display may display a notification requesting that the user identify an amount of the monetary withdrawal that was spent with the merchant at the merchant location. The user may utilize the user device to generate a response (e.g., to the notification) indicating the amount of the monetary withdrawal from the transaction device that was spent with the merchant.

The user may cause the user device to provide the response to the verification platform. As further shown in FIG. 1D, and by reference number 140, the verification platform may receive, from the user device, the response indicating the amount of the monetary withdrawal from the transaction device that was spent with the merchant (e.g., the response may indicate that the user “spent $25 on pizza at Joe's Pizza” from a $100 cash withdrawal at the transaction device).

As shown in FIG. 1E, and by reference number 145, the verification platform may utilize natural language processing to parse the response and identify the amount of the monetary withdrawal that was spent with the merchant. In some implementations, the verification platform may utilize a natural language processing technique, a computational linguistics technique, a text analysis technique, and/or the like, with the response in order to parse the response and identify the amount of the monetary withdrawal that was spent with the merchant. For example, the verification platform may apply natural language processing to interpret the response (e.g., “I spent $25 at Joe's Pizza”) and generate additional data associated with the potential meaning of data within the response (e.g., that the user spent at least a portion of $25 on pizza at Joe's pizza, that the user still has $75 in cash remaining from the $100 cash withdrawal, and/or the like).

As shown in FIG. 1F, and by reference number 150, the verification platform may associate the amount of the monetary withdrawal (e.g., identified from the response) with information identifying the merchant, a category of the merchant, and an account of the user. In some implementations, the information identifying the merchant may include information identifying a name of the merchant, a location of the merchant, products and/or services offered by the merchant, promotions offered by the merchant, and/or the like. In some implementations, the information identifying the category of the merchant may include information identifying merchant category codes, a service category of the merchant (e.g., restaurant service, entertainment service, a grocery service, a technology service, etc.), a product category of the merchant (e.g., food, electronics, gasoline, etc.), and/or the like. In some implementations, the information identifying the account of the user may include information identifying the account with the financial institution, the transaction card, a name of the user, an account number, and/or the like.

As shown in FIG. 1G, and by reference number 155, the verification platform may perform one or more actions based on associating the amount of the monetary withdrawal with the information identifying the merchant, the category of the merchant, and the account of the user. For example, the one or more actions may include the verification platform causing transactions of the user with transaction devices to be distinguished. In this way, the verification platform enables the user to categorize and account for how cash withdrawals are spent.

In some implementations, the one or more actions may include the verification platform storing, in a data structure, the association of the amount of the monetary withdrawal with the information identifying the merchant, the category of the merchant, and the account of the user. For example, the verification platform may store information associating the $25 spent at Joe's Pizza with an identifier for Joe's Pizza, a restaurant category, and the account of the user. In this way, the verification platform enables the user to review the stored information and easily determine how the user is spending cash withdrawals.

In some implementations, the one or more actions may include the verification platform generating and/or updating a budget for the user based on the association of the amount of the monetary withdrawal with the information identifying the merchant, the category of the merchant, and the account of the user. In this way, the verification platform enables the user to generate or update budgets based on cash withdrawals, which conserves computing resources and network resources that would otherwise be wasted attempting to generate budgets.

In some implementations, the one or more actions may include the verification platform generating a search result based on the association of the amount of the monetary withdrawal with the information identifying the merchant, the category of the merchant, and the account of the user. For example, the user may perform a search of the association of the amount of the monetary withdrawal with the information identifying the merchant, the category of the merchant, and the account of the user (e.g., for a particular transaction) and the verification may generate a search result based on the search. In this way, the verification platform enables the user to quickly identify particular transactions associated with cash withdrawals, which conserves computing resources and network resources that would otherwise be wasted attempting to identify such transactions.

In some implementations, the one or more actions may include the verification platform organizing an account of the user based on the association of the amount of the monetary withdrawal with the information identifying the merchant, the category of the merchant, and the account of the user. In this way, the verification platform enables the user to quickly review the account based on merchant categories, expenditures from cash withdrawals, and/or the like.

In some implementations, the one or more actions may include the verification platform causing the transaction card of the user to be locked (e.g., when the transaction card has been stolen and is being utilized at locations not associated with the user, when the amount of spending exceeds a threshold amount of spending, set by the user, in a particular spending category, and/or the like). In this way, the verification platform prevents utilization of a transaction card, which conserves resources that would otherwise be wasted in attempting to make purchases with the transaction card.

In some implementations, the one or more actions may include the verification platform causing a post, associated with the merchant, to a social media account associated with the user (e.g., “I ate at Joe's Pizza today”). Thus, the verification platform may create a post and automatically transmit the post to a social media platform associated with the user. In this way, the verification platform enables the user to post recent information about events in the user's life.

In some implementations, the one or more actions may include the verification platform requesting that the user identify a category for the amount of the monetary withdrawal (e.g., food, entertainment, etc.). In this way, the verification platform obtains information that enables the verification platform to organize the account of the user with respect to cash withdrawals.

In this way, several different stages of the process for associating merchant data with a monetary withdrawal from a transaction device based on a location of the transaction device may be automated and involve the use of sensor data. Furthermore, implementations described herein use a rigorous, computerized process to perform tasks or roles that were not previously performed. For example, currently there does not exist a technique that associates merchant data with a monetary withdrawal from a transaction device based on a location of the transaction device.

As indicated above, FIGS. 1A-1G are provided merely as examples. Other examples may differ from what is described with regard to FIGS. 1A-1G.

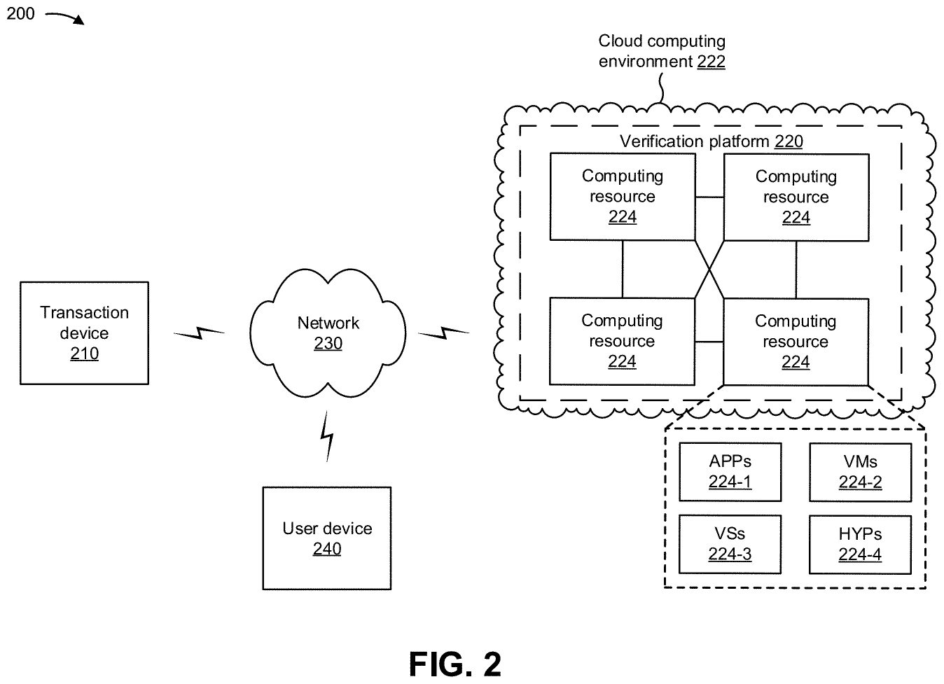

FIG. 2 is a diagram of an example environment 200 in which systems and/or methods, described herein, may be implemented. As shown in FIG. 2, environment 200 may include a transaction device 210, a verification platform 220, a network 230, and a user device 240. Devices of environment 200 may interconnect via wired connections, wireless connections, or a combination of wired and wireless connections.

Transaction device 210 includes one or more devices capable of receiving, generating, storing, processing, and/or providing information, such as information described herein. For example, transaction device 210 may include an automated teller machine (ATM) device, a point of sale (POS) device, a kiosk device, and/or the like.

The ATM device may include an electronic telecommunications device that enables customers of financial institutions to perform financial transactions, such as cash withdrawals, deposits, transferring funds, obtaining account information, and/or the like, at any time and without direct interaction with employees of the financial institutions. The POS device may include an electronic device used to process transaction card payments at retail locations. The POS device may read information from a transaction card (e.g., a credit card, a debit card, a gift card, and/or the like), and may determine whether there are sufficient funds in an account associated with the transaction card for a transaction. The POS device may transfer funds from the account associated with the transaction card to an account of a retailer and may record the transaction. The kiosk device may include a computer terminal featuring specialized hardware and/or software that provides access to information and/or applications for communication, commerce, entertainment, education, and/or the like.

In some implementations, transaction device 210 may include an input element (e.g., a keypad, a keyboard, a touchscreen display, and/or the like) for receiving input data from a user of the transaction device. In some implementations, transaction device 210 may include more than one input element (e.g., a keypad and a touchscreen display).

Verification platform 220 includes one or more devices that may associate merchant data with a monetary withdrawal from a transaction device based on a location of the transaction device. In some implementations, verification platform 220 may be modular such that certain software components may be swapped in or out depending on a particular need. As such, verification platform 220 may be easily and/or quickly reconfigured for different uses. In some implementations, verification platform 220 may receive information from and/or transmit information to one or more transaction devices 210 and/or user devices 240.

In some implementations, as shown, verification platform 220 may be hosted in a cloud computing environment 222. Notably, while implementations described herein describe verification platform 220 as being hosted in cloud computing environment 222, in some implementations, verification platform 220 may be non-cloud-based (i.e., may be implemented outside of a cloud computing environment) or may be partially cloud-based.

Cloud computing environment 222 includes an environment that may host verification platform 220. Cloud computing environment 222 may provide computation, software, data access, storage, etc. services that do not require end-user knowledge of a physical location and configuration of system(s) and/or device(s) that host verification platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host verification platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by transaction device 210 and/or user device 240. Application 224-1 may eliminate a need to install and execute the software applications on transaction device 210 and/or user device 240. For example, application 224-1 may include software associated with verification platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program and may support a single process. In some implementations, virtual machine 224-2 may execute on behalf of a user (e.g., a user of transaction device 210 and/or user device 240 or an operator of verification platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may provide administrators of the storage system with flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

User device 240 includes one or more devices capable of receiving, generating, storing, processing, and/or providing information, such as information described herein. For example, user device 240 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device 240 may receive information from and/or transmit information to transaction device 210 and/or verification platform 220.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device and/or a single device shown in FIG. 2 may be implemented as multiple, distributed devices. Additionally, or alternatively, a set of devices (e.g., one or more devices) of environment 200 may perform one or more functions described as being performed by another set of devices of environment 200.

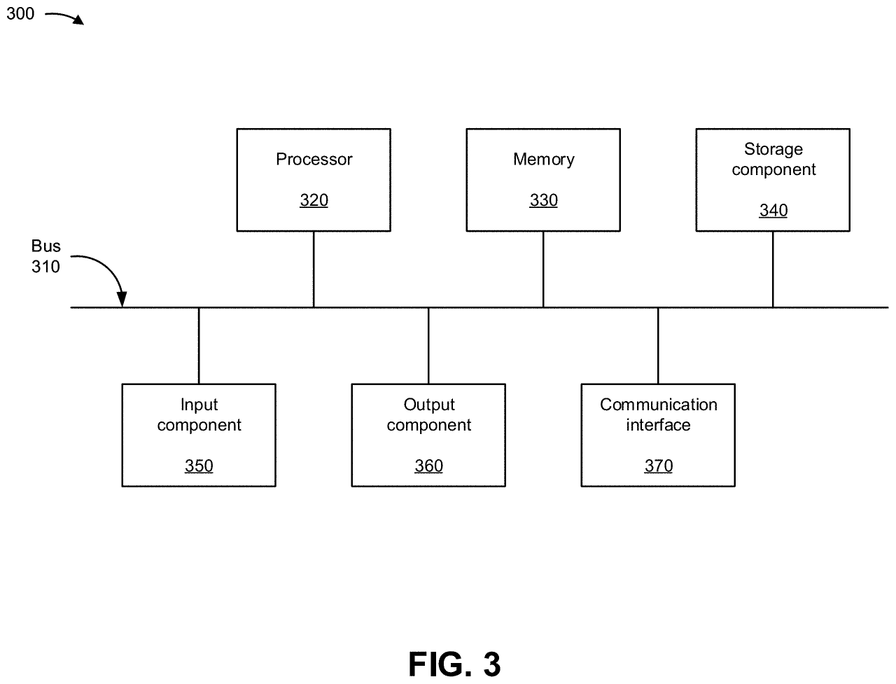

FIG. 3 is a diagram of example components of a device 300. Device 300 may correspond to transaction device 210, verification platform 220, computing resource 224, and/or user device 240. In some implementations, transaction device 210, verification platform 220, computing resource 224, and/or user device 240 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

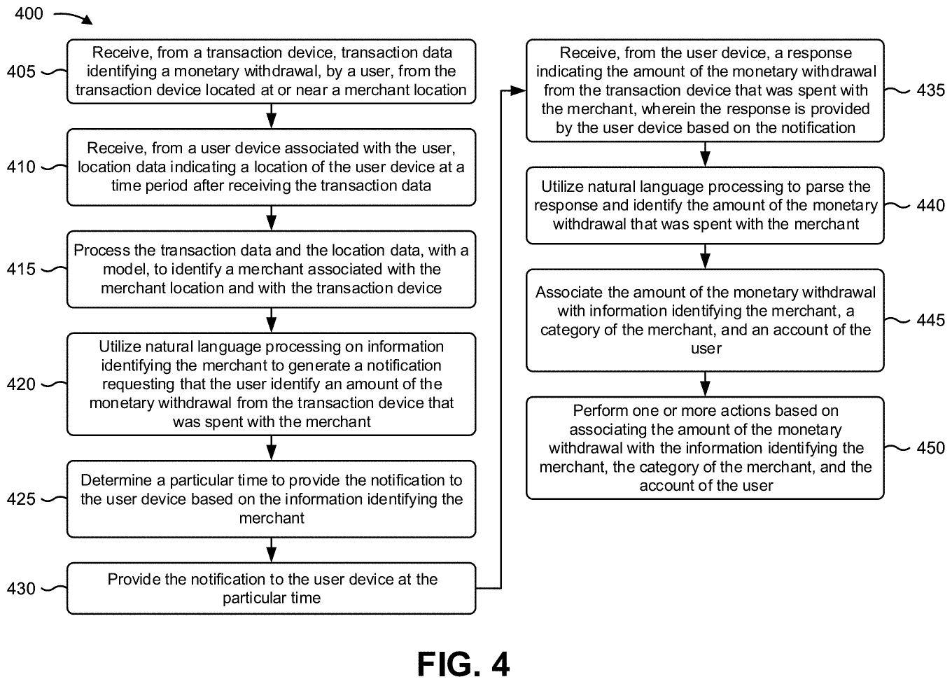

FIG. 4 is a flow chart of an example process 400 for associating merchant data with a monetary withdrawal from a transaction device based on a location of the transaction device. In some implementations, one or more process blocks of FIG. 4 may be performed by a verification platform (e.g., verification platform 220). In some implementations, one or more process blocks of FIG. 4 may be performed by another device or a group of devices separate from or including the verification platform, such as a transaction device (e.g., transaction device 210) and/or a user device (e.g., user device 240).

As shown in FIG. 4, process 400 may include receiving, from a transaction device, transaction data identifying a monetary withdrawal, by a user, from the transaction device located at or near a merchant location (block 405). For example, the verification platform (e.g., using computing resource 224, processor 320, communication interface 370, and/or the like) may receive, from a transaction device, transaction data identifying a monetary withdrawal, by a user, from the transaction device located at or near a merchant location, as described above in connection with FIGS. 1A-2.

As further shown in FIG. 4, process 400 may include receiving, from a user device associated with the user, location data indicating a location of the user device at a time period after receiving the transaction data (block 410). For example, the verification platform (e.g., using computing resource 224, processor 320, communication interface 370, and/or the like) may receive, from a user device associated with the user, location data indicating a location of the user device at a time period after receiving the transaction data, as described above in connection with FIGS. 1A-2.

As further shown in FIG. 4, process 400 may include processing the transaction data and the location data, with a model, to identify a merchant associated with the merchant location and with the transaction device (block 415). For example, the verification platform (e.g., using computing resource 224, processor 320, storage component 340, and/or the like) may process the transaction data and the location data, with a model, to identify a merchant associated with the merchant location and with the transaction device, as described above in connection with FIGS. 1A-2.

As further shown in FIG. 4, process 400 may include utilizing natural language processing on information identifying the merchant to generate a notification requesting that the user identify an amount of the monetary withdrawal from the transaction device that was spent with the merchant (block 420). For example, the verification platform (e.g., using computing resource 224, processor 320, memory 330, and/or the like) may utilize natural language processing on information identifying the merchant to generate a notification requesting that the user identify an amount of the monetary withdrawal from the transaction device that was spent with the merchant, as described above in connection with FIGS. 1A-2.

As further shown in FIG. 4, process 400 may include determining a particular time to provide the notification to the user device based on the information identifying the merchant (block 425). For example, the verification platform (e.g., using computing resource 224, processor 320, storage component 340, and/or the like) may determine a particular time to provide the notification to the user device based on the information identifying the merchant, as described above in connection with FIGS. 1A-2.

As further shown in FIG. 4, process 400 may include providing the notification to the user device at the particular time (block 430). For example, the verification platform (e.g., using computing resource 224, processor 320, memory 330, communication interface 370, and/or the like) may provide the notification to the user device at the particular time, as described above in connection with FIGS. 1A-2.

As further shown in FIG. 4, process 400 may include receiving, from the user device, a response indicating the amount of the monetary withdrawal from the transaction device that was spent with the merchant, wherein the response is provided by the user device based on the notification (block 435). For example, the verification platform (e.g., using computing resource 224, processor 320, communication interface 370, and/or the like) may receive, from the user device, a response indicating the amount of the monetary withdrawal from the transaction device that was spent with the merchant, as described above in connection with FIGS. 1A-2. In some implementations, the response may be provided by the user device based on the notification.

As further shown in FIG. 4, process 400 may include utilizing natural language processing to parse the response and identify the amount of the monetary withdrawal that was spent with the merchant (block 440). For example, the verification platform (e.g., using computing resource 224, processor 320, memory 330, and/or the like) may utilize natural language processing to parse the response and identify the amount of the monetary withdrawal that was spent with the merchant, as described above in connection with FIGS. 1A-2.

As further shown in FIG. 4, process 400 may include associating the amount of the monetary withdrawal with information identifying the merchant, a category of the merchant, and an account of the user (block 445). For example, the verification platform (e.g., using computing resource 224, processor 320, storage component 340, and/or the like) may associate the amount of the monetary withdrawal with information identifying the merchant, a category of the merchant, and an account of the user, as described above in connection with FIGS. 1A-2.

As further shown in FIG. 4, process 400 may include performing one or more actions based on associating the amount of the monetary withdrawal with the information identifying the merchant, the category of the merchant, and the account of the user (block 450). For example, the verification platform (e.g., using computing resource 224, processor 320, memory 330, communication interface 370, and/or the like) may perform one or more actions based on associating the amount of the monetary withdrawal with the information identifying the merchant, the category of the merchant, and the account of the user, as described above in connection with FIGS. 1A-2.

Process 400 may include additional implementations, such as any single implementation or any combination of implementations described below and/or described with regard to any other process described herein.

In some implementations, when performing the one or more actions, the verification platform may store information identifying an association of the amount of the monetary withdrawal with the information identifying the merchant, the category of the merchant, and the account of the user; may generate a budget for the user based on the information identifying the association of the amount of the monetary withdrawal the information identifying the merchant, the category of the merchant, and the account of the user; may update the budget for the user based on the information identifying the association of the amount of the monetary withdrawal the information identifying the merchant, the category of the merchant, and the account of the user; may generate a search result based on the information identifying the association of the amount of the monetary withdrawal the information identifying the merchant, the category of the merchant, and the account of the user; and/or may organize the account of the user based on the information identifying the association of the amount of the monetary withdrawal the information identifying the merchant, the category of the merchant, and the account of the user.

In some implementations, the verification platform may determine that the transaction device is located at or near the merchant location based on global positioning system (GPS) coordinates associated with the transaction device and the merchant location, third-party data, and/or a tag associated with the transaction device. In some implementations, the verification platform may determine that the transaction device is located near the merchant location based on a threshold distance between a location of the transaction device and the merchant location.

In some implementations, when determining the particular time to provide the notification to the user device, the verification platform may determine, based on the location data, that the user is leaving the merchant location, and may determine the particular time as when the user is leaving the merchant location. In some implementations, when determining the particular time to provide the notification to the user device, the verification platform may determine a first particular time to provide the notification when the category of the merchant is a first category, and may determine a second particular time to provide the notification when the category of the merchant is a second category, where the first category is different than the second category. In some implementations, when determining the particular time to provide the notification to the user device, the verification platform may process the transaction data and the location data, with the model, to determine the particular time to provide the notification to the user device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

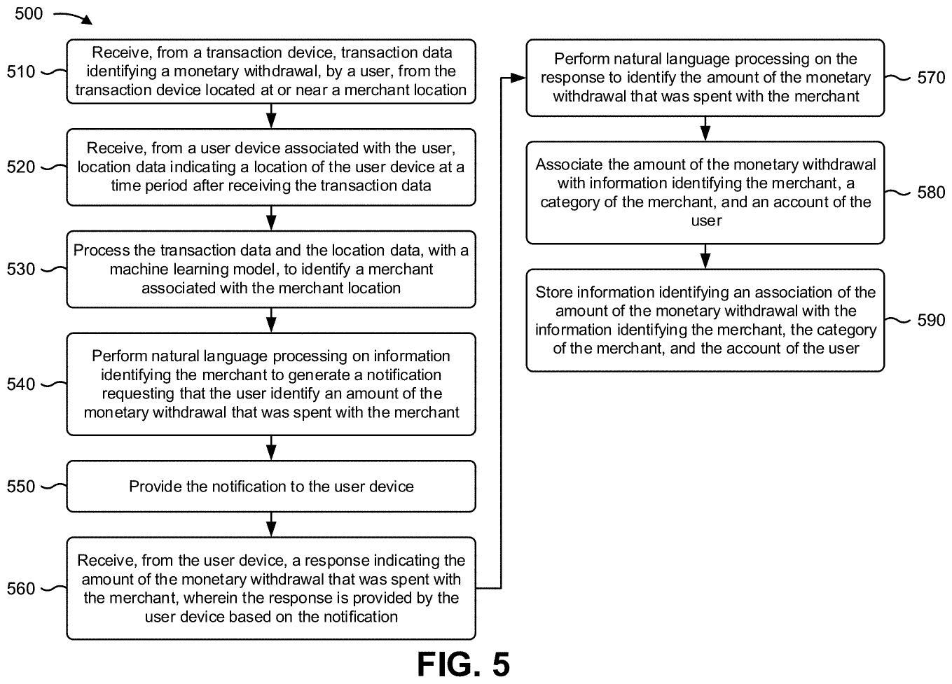

FIG. 5 is a flow chart of an example process 500 for associating merchant data with a monetary withdrawal from a transaction device based on a location of the transaction device. In some implementations, one or more process blocks of FIG. 5 may be performed by a verification platform (e.g., verification platform 220). In some implementations, one or more process blocks of FIG. 5 may be performed by another device or a group of devices separate from or including the verification platform, such as a transaction device (e.g., transaction device 210) and/or a user device (e.g., user device 240).

As shown in FIG. 5, process 500 may include receiving, from a transaction device, transaction data identifying a monetary withdrawal, by a user, from the transaction device located at or near a merchant location (block 510). For example, the verification platform (e.g., using computing resource 224, processor 320, communication interface 370, and/or the like) may receive, from a transaction device, transaction data identifying a monetary withdrawal, by a user, from the transaction device located at or near a merchant location, as described above in connection with FIGS. 1A-2.

As further shown in FIG. 5, process 500 may include receiving, from a user device associated with the user, location data indicating a location of the user device at a time period after receiving the transaction data (block 520). For example, the verification platform (e.g., using computing resource 224, processor 320, communication interface 370, and/or the like) may receive, from a user device associated with the user, location data indicating a location of the user device at a time period after receiving the transaction data, as described above in connection with FIGS. 1A-2.

As further shown in FIG. 5, process 500 may include processing the transaction data and the location data, with a machine learning model, to identify a merchant associated with the merchant location (block 530). For example, the verification platform (e.g., using computing resource 224, processor 320, storage component 340, and/or the like) may process the transaction data and the location data, with a machine learning model, to identify a merchant associated with the merchant location, as described above in connection with FIGS. 1A-2.

As further shown in FIG. 5, process 500 may include performing natural language processing on information identifying the merchant to generate a notification requesting that the user identify an amount of the monetary withdrawal that was spent with the merchant (block 540). For example, the verification platform (e.g., using computing resource 224, processor 320, memory 330, and/or the like) may perform natural language processing on information identifying the merchant to generate a notification requesting that the user identify an amount of the monetary withdrawal that was spent with the merchant, as described above in connection with FIGS. 1A-2.

As further shown in FIG. 5, process 500 may include providing the notification to the user device (block 550). For example, the verification platform (e.g., using computing resource 224, processor 320, communication interface 370, and/or the like) may provide the notification to the user device, as described above in connection with FIGS. 1A-2.

As further shown in FIG. 5, process 500 may include receiving, from the user device, a response indicating the amount of the monetary withdrawal that was spent with the merchant, wherein the response is provided by the user device based on the notification (block 560). For example, the verification platform (e.g., using computing resource 224, processor 320, communication interface 370, and/or the like) may receive, from the user device, a response indicating the amount of the monetary withdrawal that was spent with the merchant, as described above in connection with FIGS. 1A-2. In some implementations, the response may be provided by the user device based on the notification.

As further shown in FIG. 5, process 500 may include performing natural language processing on the response to identify the amount of the monetary withdrawal that was spent with the merchant (block 570). For example, the verification platform (e.g., using computing resource 224, processor 320, memory 330, and/or the like) may perform natural language processing on the response to identify the amount of the monetary withdrawal that was spent with the merchant, as described above in connection with FIGS. 1A-2.

As further shown in FIG. 5, process 500 may include associating the amount of the monetary withdrawal with information identifying the merchant, a category of the merchant, and an account of the user (block 580). For example, the verification platform (e.g., using computing resource 224, processor 320, storage component 340, and/or the like) may associate the amount of the monetary withdrawal with information identifying the merchant, a category of the merchant, and an account of the user, as described above in connection with FIGS. 1A-2.

As further shown in FIG. 5, process 500 may include storing information identifying an association of the amount of the monetary withdrawal with the information identifying the merchant, the category of the merchant, and the account of the user (block 590). For example, the verification platform (e.g., using computing resource 224, processor 320, memory 330, and/or the like) may store information identifying an association of the amount of the monetary withdrawal with the information identifying the merchant, the category of the merchant, and the account of the user, as described above in connection with FIGS. 1A-2.

Process 500 may include additional implementations, such as any single implementation or any combination of implementations described below and/or described with regard to any other process described herein.

In some implementations, the verification platform may generate a budget for the user based on the information identifying the association of the amount of the monetary withdrawal the information identifying the merchant, the category of the merchant, and the account of the user; may update the budget for the user based on the information identifying the association of the amount of the monetary withdrawal the information identifying the merchant, the category of the merchant, and the account of the user; may generate a search result based on the information identifying the association of the amount of the monetary withdrawal the information identifying the merchant, the category of the merchant, and the account of the user; and/or may organize the account of the user based on the information identifying the association of the amount of the monetary withdrawal the information identifying the merchant, the category of the merchant, and the account of the user.

In some implementations, the verification platform may determine that the transaction device is located at or near the merchant location based on global positioning system (GPS) coordinates associated with the transaction device and the merchant location. In some implementations, the verification platform may determine that the transaction device is located at or near the merchant location based on a threshold distance between a location of the transaction device and the merchant location. In some implementations, the verification platform may determine, based on the location data, that the user is leaving the merchant location, and, when providing the notification to the user device, the verification platform may provide the notification to the user device when the user is leaving the merchant location.

In some implementations, the verification platform may determine a first particular time to provide the notification to the user device when the category of the merchant is a first category, and/or determine a second particular time to provide the notification to the user device when the category of the merchant is a second category, where the first category is different than the second category, and, when providing the notification to the user device, the verification platform may provide the notification to the user device at the first particular time or the second particular time. In some implementations, the verification platform may determine a particular time to provide the notification to the user device based on the information identifying the merchant, and, when providing the notification to the user device, the verification platform may provide the notification to the user device at the particular time.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

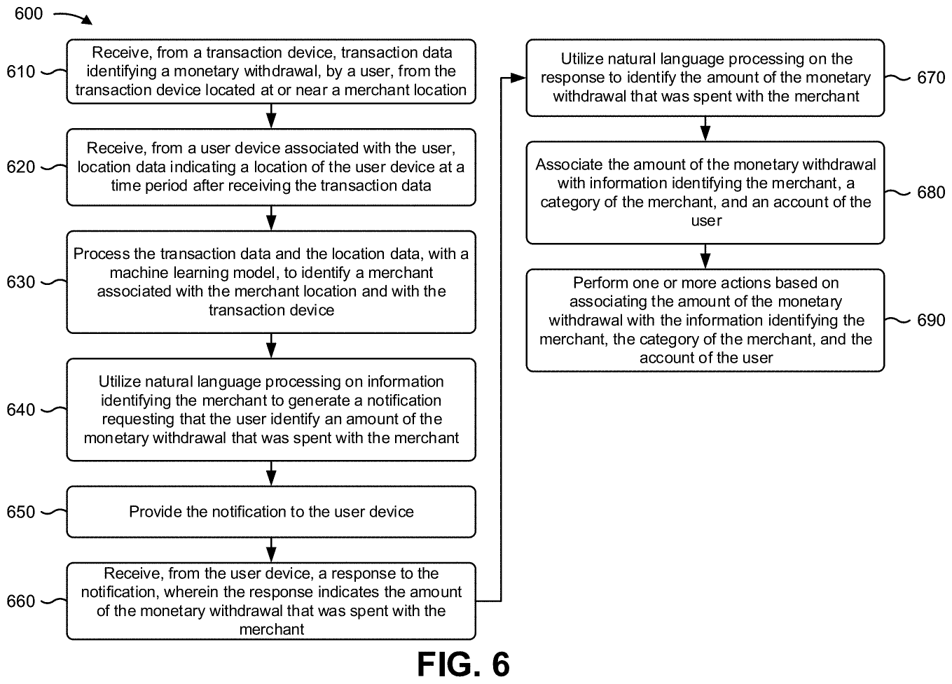

FIG. 6 is a flow chart of an example process 600 for associating merchant data with a monetary withdrawal from a transaction device based on a location of the transaction device. In some implementations, one or more process blocks of FIG. 6 may be performed by a verification platform (e.g., verification platform 220). In some implementations, one or more process blocks of FIG. 6 may be performed by another device or a group of devices separate from or including the verification platform, such as a transaction device (e.g., transaction device 210) and/or a user device (e.g., user device 240).

As shown in FIG. 6, process 600 may include receiving, from a transaction device, transaction data identifying a monetary withdrawal, by a user, from the transaction device located at or near a merchant location (block 610). For example, the verification platform (e.g., using computing resource 224, processor 320, communication interface 370, and/or the like) may receive, from a transaction device, transaction data identifying a monetary withdrawal, by a user, from the transaction device located at or near a merchant location, as described above in connection with FIGS. 1A-2.

As further shown in FIG. 6, process 600 may include receiving, from a user device associated with the user, location data indicating a location of the user device at a time period after receiving the transaction data (block 620). For example, the verification platform (e.g., using computing resource 224, processor 320, communication interface 370, and/or the like) may receive, from a user device associated with the user, location data indicating a location of the user device at a time period after receiving the transaction data, as described above in connection with FIGS. 1A-2.

As further shown in FIG. 6, process 600 may include processing the transaction data and the location data, with a machine learning model, to identify a merchant associated with the merchant location and with the transaction device (block 630). For example, the verification platform (e.g., using computing resource 224, processor 320, storage component 340, and/or the like) may process the transaction data and the location data, with a machine learning model, to identify a merchant associated with the merchant location and with the transaction device, as described above in connection with FIGS. 1A-2.

As further shown in FIG. 6, process 600 may include utilizing natural language processing on information identifying the merchant to generate a notification requesting that the user identify an amount of the monetary withdrawal that was spent with the merchant (block 640). For example, the verification platform (e.g., using computing resource 224, processor 320, memory 330, and/or the like) may utilize natural language processing on information identifying the merchant to generate a notification requesting that the user identify an amount of the monetary withdrawal that was spent with the merchant, as described above in connection with FIGS. 1A-2.

As further shown in FIG. 6, process 600 may include providing the notification to the user device (block 650). For example, the verification platform (e.g., using computing resource 224, processor 320, communication interface 370, and/or the like) may provide the notification to the user device, as described above in connection with FIGS. 1A-2.

As further shown in FIG. 6, process 600 may include receiving, from the user device, a response to the notification, wherein the response indicates the amount of the monetary withdrawal that was spent with the merchant (block 660). For example, the verification platform (e.g., using computing resource 224, processor 320, communication interface 370, and/or the like) may receive, from the user device, a response to the notification, as described above in connection with FIGS. 1A-2. In some implementations, the response may indicate the amount of the monetary withdrawal that was spent with the merchant.

As further shown in FIG. 6, process 600 may include utilizing natural language processing on the response to identify the amount of the monetary withdrawal that was spent with the merchant (block 670). For example, the verification platform (e.g., using computing resource 224, processor 320, memory 330, memory 330, and/or the like) may utilize natural language processing on the response to identify the amount of the monetary withdrawal that was spent with the merchant, as described above in connection with FIGS. 1A-2.

As further shown in FIG. 6, process 600 may include associating the amount of the monetary withdrawal with information identifying the merchant, a category of the merchant, and an account of the user (block 680). For example, the verification platform (e.g., using computing resource 224, processor 320, storage component 340, and/or the like) may associate the amount of the monetary withdrawal with information identifying the merchant, a category of the merchant, and an account of the user, as described above in connection with FIGS. 1A-2.

As further shown in FIG. 6, process 600 may include performing one or more actions based on associating the amount of the monetary withdrawal with the information identifying the merchant, the category of the merchant, and the account of the user (block 690). For example, the verification platform (e.g., using computing resource 224, processor 320, memory 330, communication interface 370, and/or the like) may perform one or more actions based on associating the amount of the monetary withdrawal with the information identifying the merchant, the category of the merchant, and the account of the user, as described above in connection with FIGS. 1A-2.

Process 600 may include additional implementations, such as any single implementation or any combination of implementations described below and/or described with regard to any other process described herein.

In some implementations, the verification platform may detect an event associated with providing the notification to the user device, and, when providing the notification to the user device, the verification platform may provide the notification to the user device based on detecting the event. In some implementations, when performing the one or more actions, the verification platform may store information identifying an association of the amount of the monetary withdrawal with the information identifying the merchant, the category of the merchant, and the account of the user; may generate a budget for the user based on the information identifying the association of the amount of the monetary withdrawal the information identifying the merchant, the category of the merchant, and the account of the user; may update the budget for the user based on the information identifying the association of the amount of the monetary withdrawal the information identifying the merchant, the category of the merchant, and the account of the user; may generate a search result based on the information identifying the association of the amount of the monetary withdrawal the information identifying the merchant, the category of the merchant, and the account of the user; and/or may organize the account of the user based on the information identifying the association of the amount of the monetary withdrawal the information identifying the merchant, the category of the merchant, and the account of the user.

In some implementations, the verification platform may determine that the transaction device is located at or near the merchant location based on global positioning system (GPS) coordinates associated with the transaction device and the merchant location, third-party data, and/or a tag associated with the transaction device. In some implementations, the verification platform may calculate a distance between a location of the transaction device and the merchant location, may determine whether the distance satisfies a threshold distance, and may determine that the transaction device is located at or near the merchant location when the distance satisfies the threshold distance. In some implementations, the verification platform may determine, based on the location data, that the user is leaving the merchant location, and, when providing the notification to the user device, the verification platform may provide the notification to the user device when the user is leaving the merchant location.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
receiving, by a device and from a transaction device, transaction data identifying a monetary withdrawal, by a user, from the transaction device located at or near a merchant location;
receiving, by the device and from a user device associated with the user, location data indicating a location of the user device at a time period after receiving the transaction data;
receiving, by the device, historical transaction data and historical location data;
training by the device, a machine learning model using an artificial neural network processing technique,
wherein training the machine learning model comprises:
performing pattern recognition using the historical transaction data and the historical location data;
processing, by the device, the transaction data and the location data, with the machine learning model, to identify a merchant associated with the merchant location and with the transaction device,
the machine learning model to:
input the transaction data and the location data,
use the pattern recognition to predict that individuals who withdraw more than a threshold amount of money, from a particular transaction device, tend to spend that money at a first merchant that is within a particular geographic distance of the transaction device, and that individuals who withdraw less than the threshold amount of money, from the particular transaction device, tend to spend that money at a second merchant that is within the particular geographic distance of the transaction device, and
output information identifying the merchant based on the pattern recognition;
utilizing, by the device, natural language processing on information identifying the merchant to generate a notification requesting that the user identify an amount of the monetary withdrawal from the transaction device that was spent with the merchant;
determining, by the device, a particular time to provide the notification to the user device based on the information identifying the merchant;
providing, by the device, the notification to the user device at the particular time;
receiving, by the device and from the user device, a response indicating the amount of the monetary withdrawal from the transaction device that was spent with the merchant,
wherein the response is provided by the user device based on the notification;
utilizing, by the device, natural language processing to parse the response and identify the amount of the monetary withdrawal that was spent with the merchant;
associating, by the device, the amount of the monetary withdrawal with information identifying the merchant, a category of the merchant, and an account of the user; and
performing, by the device, one or more actions based on associating the amount of the monetary withdrawal with the information identifying the merchant, the category of the merchant, and the account of the user.

2. The method of claim 1, wherein performing the one or more actions includes one or more of:
storing information identifying an association of the amount of the monetary withdrawal with the information identifying the merchant, the category of the merchant, and the account of the user;
generating a budget for the user based on the information identifying the association of the amount of the monetary withdrawal the information identifying the merchant, the category of the merchant, and the account of the user;
updating the budget for the user based on the information identifying the association of the amount of the monetary withdrawal the information identifying the merchant, the category of the merchant, and the account of the user;
generating a search result based on the information identifying the association of the amount of the monetary withdrawal the information identifying the merchant, the category of the merchant, and the account of the user; or
organizing the account of the user based on the information identifying the association of the amount of the monetary withdrawal the information identifying the merchant, the category of the merchant, and the account of the user.

3. The method of claim 1, further comprising:
determining that the transaction device is located at or near the merchant location based on one or more of:
global positioning system (GPS) coordinates associated with the transaction device and the merchant location,
third-party data, or
a tag associated with the transaction device.

4. The method of claim 1, further comprising:
determining that the transaction device is located near the merchant location based on a threshold distance between a location of the transaction device and the merchant location.

5. The method of claim 1, wherein determining the particular time to provide the notification to the user device includes:
determining, based on the location data, that the user is leaving the merchant location; and
determining the particular time as when the user is leaving the merchant location.

6. The method of claim 1, wherein determining the particular time to provide the notification to the user device includes:
determining a first particular time to provide the notification when the category of the merchant is a first category; and
determining a second particular time to provide the notification when the category of the merchant is a second category,
wherein the first category is different than the second category.

7. The method of claim 1, wherein determining the particular time to provide the notification to the user device includes:
processing the transaction data and the location data, with the machine learning model, to determine the particular time to provide the notification to the user device.

8-14. (canceled)

15. A non-transitory computer-readable medium storing instructions, the instructions comprising:
one or more instructions that, when executed by one or more processors of a device, cause the one or more processors to:
receive, from a transaction device, transaction data identifying a monetary withdrawal, by a user, from the transaction device located at or near a merchant location;
receive, from a user device associated with the user, location data indicating a location of the user device at a time period after receiving the transaction data;
receive historical transaction data and historical location data;
train a machine learning model using an artificial neural network processing technique,
wherein the one or more instructions, that cause the one or more processors to train the machine learning model, cause the one or more processors to:
perform pattern recognition using the historical transaction data and the historical location data;
process the transaction data and the location data, with the machine learning model, to identify a merchant associated with the merchant location and with the transaction device,
the machine learning model to:
input the transaction data and the location data,
use the pattern recognition to predict that individuals who withdraw more than a threshold amount of money, from a particular transaction device, tend to spend that money at a first merchant that is within a particular geographic distance of the transaction device, and that individuals who withdraw less than the threshold amount of money, from the particular transaction device, tend to spend that money at a second merchant that is within the particular geographic distance of the transaction device, and
output information identifying the merchant based on the pattern recognition;
utilize natural language processing on information identifying the merchant to generate a notification requesting that the user identify an amount of the monetary withdrawal that was spent with the merchant;
provide the notification to the user device;
receive, from the user device, a response to the notification,
wherein the response indicates the amount of the monetary withdrawal that was spent with the merchant;
utilize natural language processing on the response to identify the amount of the monetary withdrawal that was spent with the merchant;
associate the amount of the monetary withdrawal with information identifying the merchant, a category of the merchant, and an account of the user; and
perform one or more actions based on associating the amount of the monetary withdrawal with the information identifying the merchant, the category of the merchant, and the account of the user.

16. The non-transitory computer-readable medium of claim 15, wherein the instructions further comprise:
one or more instructions that, when executed by the one or more processors, cause the one or more processors to:
detect an event associated with providing the notification to the user device, and
wherein the one or more instructions, that cause the one or more processors to provide the notification to the user device, cause the one or more processors to:
provide the notification to the user device based on detecting the event.

17. The non-transitory computer-readable medium of claim 15, wherein the one or more instructions, that cause the one or more processors to perform the one or more actions, cause the one or more processors to one or more of:
store information identifying an association of the amount of the monetary withdrawal with the information identifying the merchant, the category of the merchant, and the account of the user;
generate a budget for the user based on the information identifying the association of the amount of the monetary withdrawal the information identifying the merchant, the category of the merchant, and the account of the user;
update the budget for the user based on the information identifying the association of the amount of the monetary withdrawal the information identifying the merchant, the category of the merchant, and the account of the user;
generate a search result based on the information identifying the association of the amount of the monetary withdrawal the information identifying the merchant, the category of the merchant, and the account of the user; or
organize the account of the user based on the information identifying the association of the amount of the monetary withdrawal the information identifying the merchant, the category of the merchant, and the account of the user.

18. The non-transitory computer-readable medium of claim 15, wherein the instructions further comprise:
one or more instructions that, when executed by the one or more processors, cause the one or more processors to:
determine that the transaction device is located at or near the merchant location based on one or more of:
global positioning system (GPS) coordinates associated with the transaction device and the merchant location,
third-party data, or
a tag associated with the transaction device.

19. The non-transitory computer-readable medium of claim 15, wherein the instructions further comprise:
one or more instructions that, when executed by the one or more processors, cause the one or more processors to:
calculate a distance between a location of the transaction device and the merchant location;
determine whether the distance satisfies a threshold distance; and
determine that the transaction device is located at or near the merchant location when the distance satisfies the threshold distance.

20. The non-transitory computer-readable medium of claim 15, wherein the instructions further comprise:
one or more instructions that, when executed by the one or more processors, cause the one or more processors to:
determine, based on the location data, that the user is leaving the merchant location, and
wherein the one or more instructions, that cause the one or more processors to provide the notification to the user device, cause the one or more processors to:
provide the notification to the user device when the user is leaving the merchant location.

21. A device, comprising:
one or more memories; and
one or more processors, communicatively coupled to the one or more memories, to:
receive, from a transaction device, transaction data identifying a monetary withdrawal, by a user, from the transaction device located at or near a merchant location;
receive, from a user device associated with the user, location data indicating a location of the user device at a time period after receiving the transaction data;
receive historical transaction data and historical location data;
train a machine learning model using an artificial neural network processing technique,
wherein the one or more processors, when training the machine learning model, are to:
perform pattern recognition using the historical transaction data and the historical location data;
process the transaction data and the location data, with the machine learning model, to identify a merchant associated with the merchant location and with the transaction device,
the machine learning model to:
input the transaction data and the location data,
use the pattern recognition to predict that individuals who withdraw more than a threshold amount of money, from a particular transaction device, tend to spend that money at a first merchant that is within a particular geographic distance of the transaction device, and that individuals who withdraw less than the threshold amount of money, from the particular transaction device, tend to spend that money at a second merchant that is within the particular geographic distance of the transaction device, and
output information identifying the merchant based on the pattern recognition;
utilize natural language processing on information identifying the merchant to generate a notification requesting that the user identify an amount of the monetary withdrawal from the transaction device that was spent with the merchant;
determine a particular time to provide the notification to the user device based on the information identifying the merchant;
provide the notification to the user device at the particular time;
receive, from the user device, a response indicating the amount of the monetary withdrawal from the transaction device that was spent with the merchant,
wherein the response is provided by the user device based on the notification;
utilize natural language processing to parse the response and identify the amount of the monetary withdrawal that was spent with the merchant;
associate the amount of the monetary withdrawal with information identifying the merchant, a category of the merchant, and an account of the user; and
perform one or more actions based on associating the amount of the monetary withdrawal with the information identifying the merchant, the category of the merchant, and the account of the user.

22. The device of claim 21, wherein the one or more processors, when performing the one or more actions, are to:
store information identifying an association of the amount of the monetary withdrawal with the information identifying the merchant, the category of the merchant, and the account of the user;
generate a budget for the user based on the information identifying the association of the amount of the monetary withdrawal the information identifying the merchant, the category of the merchant, and the account of the user;
update the budget for the user based on the information identifying the association of the amount of the monetary withdrawal the information identifying the merchant, the category of the merchant, and the account of the user;
generate a search result based on the information identifying an association of the amount of the monetary withdrawal the information identifying the merchant, the category of the merchant, and the account of the user; or
organize the account of the user based on the information identifying the association of the amount of the monetary withdrawal the information identifying the merchant, the category of the merchant, and the account of the user.

23. The device of claim 21, wherein the one or more processors are further to:
determine that the transaction device is located at or near the merchant location based on one or more of:
global positioning system (GPS) coordinates associated with the transaction device and the merchant location,
third-party data, or
a tag associated with the transaction device.

24. The device of claim 21, wherein the one or more processors are further to:
determine that the transaction device is located near the merchant location based on a threshold distance between a location of the transaction device and the merchant location.

25. The device of claim 21, wherein the one or more processors, when determining the particular time to provide the notification to the user device, are to:
determine based on the location data, that the user is leaving the merchant location; and
determine the particular time as when the user is leaving the merchant location.

26. The device of claim 21, wherein the one or more processors are further to:
calculate a distance between a location of the transaction device and the merchant location;
determine whether the distance satisfies a threshold distance; and
determine that the transaction device is located at or near the merchant location when the distance satisfies the threshold distance.

27. The device of claim 21, wherein the one or more processors, when determining the particular time to provide the notification to the user device, are to:
process the transaction data and the location data, with the machine learning model, to determine the particular time to provide the notification to the user device.
